(19) United States
(12) Patent Application Publication
(10) Pub. No.: US 2005/0101505 A1
(43) Pub. Date: May 12, 2005

(54) Liquid laundry detergent composition having improved color-care properties

(76) Inventor: Daniel Wood, Phoenix, AZ (US)

Correspondence Address: SNELL & WILMER, LLP, ONE ARIZONA CENTER, 400 E. VAN BUREN, PHOENIZ, AZ, 85004-2202, US

(21) Appl. No.: 10/703,196

(22) Filed: Nov. 6, 2003

(51) Int. Cl. C11D 17/00

(52) U.S. Cl. 510/337

(57) ABSTRACT

A liquid laundry detergent composition that provides improved fabric color-care properties, which includes an anionic surfactant component, a nonionic surfactant component, an amphoteric surfactant component, a cationic dye fixative, a polymer component, a fragrance component, and a liquid carrier.

### FIELD OF INVENTION

The present invention relates generally to a liquid detergent composition and more particularly, to a liquid detergent composition having improved fabric color-care properties.

### BACKGROUND OF THE INVENTION

Laundry detergents of various formulations are, of course, well known. Many laundry detergent formulations have relatively high amounts of surfactants, often 10% by weight or greater. Among other things, surfactants promote and facilitate the removal of soils and stains from fabric articles laundered in wash solutions formed from such liquid detergents and water. Often, these high-surfactant laundry detergents have both nonionic and anionic surfactant components. Nonionic surfactant components, which are typically relatively expensive components of liquid laundry detergents, are generally added to laundry detergents to remove soils and stains from fabric articles, particularly oil and grease.

Anionic surfactants also may be added to laundry detergents to facilitate the removal of soils and stains from fabric articles. When present above certain amounts, however, anionic surfactants may promote the redeposition of soil particles from the dirty wash liquor on the fabric articles being laundered. Unless inhibited, such redeposition on the fabrics tends to create unsightly films and spotting. After several wash cycles, particularly in the case of colored fabrics, such redeposition can result in fading or other loss of color.

In addition to actual or perceived color loss or fading of fabric articles from soil redeposition, diminished color intensity in fabric articles is a common result of repeated laundering, especially with laundry detergents containing bleaching agents. Use of certain types of dye fixatives in combination with detersive surfactants has been proposed, such as those disclosed in U.S. Pat. No. 6,156,722, issued to Panandiker et al., entitled “Laundry Detergent Formulations Comprising Dye Fixatives.” Such detergent formulations, however, generally have included phosphate and/or nonphosphorous detergent builders, which are undesirable.

What is needed in the art is a liquid laundry detergent composition that achieves the performance characteristics of a high surfactant laundry detergent while remaining gentle to fabric articles insofar as soil redeposition, color fading, and diminished color intensity are avoided.

### SUMMARY OF THE INVENTION

This summary of the invention is intended to introduce the reader to various exemplary aspects of the invention. Particular aspects of the invention are pointed out in other sections hereinbelow, and the invention is set forth in the appended claims which alone demarcate its scope.

In accordance with an exemplary embodiment of the invention, a liquid laundry detergent composition is provided. The liquid laundry detergent composition includes an anionic surfactant component, a nonionic surfactant component, an amphoteric surfactant component, a cationic dye fixative, a polymer component, a fragrance component, and a liquid carrier. The anionic surfactant component preferably is present in an amount of from about 3% to about 10% by weight of the composition. The nonionic surfactant component preferably is present in an amount of from about 5% to about 12% by weight of the composition. The amphoteric surfactant component preferably is present in an amount of from about 0.5% to about 5% by weight of the composition. The cationic dye fixative preferably is present in an amount of from about 0.1% to about 2.0% by weight of the composition. The polymer component preferably is present in an amount of from about 0.1% to about 1% by weight of the composition. The fragrance component preferably is present in an amount of from about 0.1% to about 1% by weight of the composition. In a preferred embodiment, the detergent composition also comprises one or more optional additives, such as, for example, pH adjusting agents, preservatives, chlorine scavenging agents, dyes, chelating agents, soil release agents, foaming or antifoaming agents, optical brighteners, enzymes, enzyme stabilizing agents, and the like.

In accordance with another exemplary embodiment of the invention, a liquid laundry detergent composition is provided. The liquid laundry detergent composition consists essentially of an anionic surfactant component, a nonionic surfactant component, an amphoteric surfactant component, a cationic dye fixative, a polymer component, a fragrance component, at least one additive, and a liquid carrier.

In accordance with one aspect of the invention, a liquid laundry detergent composition is provided that provides improved fabric color-care properties.

In accordance with another aspect of the invention, a laundry detergent composition is provided that stably combines color preservation and redeposition inhibiting agents with a triple-surfactant cleaning system.

### DETAILED DESCRIPTION

The following descriptions are of exemplary embodiments of the invention only, and are not intended to limit the scope, applicability or configuration of the invention in any way.

Rather, the following description is intended to provide convenient illustrations for implementing various embodiments of the invention. As will become apparent, various changes may be made in the function and arrangement of the elements described in these embodiments without departing from the sprit and scope of the invention.

In accordance with an exemplary embodiment of the present invention, The liquid laundry detergent composition includes an anionic surfactant component, a nonionic surfactant component, an amphoteric surfactant component, a cationic dye fixative, a polymer component, a fragrance component, and a liquid carrier.

Nonionic Surfactant

The nonionic surfactant component is present in an amount of from about 5% to about 12% by weight of the composition.

In a preferred embodiment of the invention, the cleaning component includes a blend of nonionic surfactants. Suitable nonionic surfactants for use in the nonionic surfactant blend in accordance with one aspect of the present invention include linear primary alcohol ethoxylates. In an exemplary embodiment of the invention, the nonionic surfactant blend of the stain remover may comprise a linear primary alcohol ethoxylate such as L48-3, such as is available as Surfonic 48-3, as manufactured by Huntsman, having an alkyl chain length of C14 to C18 and 3 moles of ethylene oxide. In another exemplary embodiment, the nonionic surfactant blend may include a linear primary alcohol ethoxylate such as L24-12, such as is available as Surfonic 24-12, as manufactured by Huntsman, having an alkyl chain length of C12 to C14 and 12 moles of ethylene oxide. In a preferred embodiment of the invention, the nonionic surfactant blend includes a mixture of linear primary alcohol ethoxylates having a range of alkyl chain lengths with a range of moles of ethylene oxide. For example, a suitable nonionic surfactant blend for use in the present invention may include a mixture of L48-3 and L24-12 linear primary alcohol ethoxylates. Nonionic surfactant blends comprising primary alcohols having varying alkyl chain lengths and varying numbers of moles of ethylene oxide groups may increase the efficiency of cleaning while also stabilizing the composition.

In another aspect of an exemplary embodiment of the invention, the nonionic surfactant blend may also comprise iso-branched primary alcohol ethoxylates. In one exemplary embodiment of the invention, a suitable iso-branched primary alcohol ethoxylate may include TDA-3, such as is available as Surfonic TDA-3, as manufactured by Huntsman.

Iso-branched primary alcohol ethoxylates can be effective cleaners for stains such as dirty motor oil stains, which also comprise branched alkyl chains. While not wishing to be bound by any particular theory, it is believed that branched chain lengths disrupt the “packing” of the surfactant into liquid and solid crystals, thus improving stability of the composition. In addition, branched chain lengths tend to be fluid at lower temperatures as compared to linear chain lengths, thus providing cleaning over a broader range of temperatures.

In another embodiment of the invention, the cleaning component may comprise any surfactant or surfactant blend that provides a cleaning benefit to the stain remover. For example, it will be appreciated that any suitable anionic, nonionic, ampholytic, zwitterionic, cationic or other surfactant or surfactant mixture may be used. Preferably, the surfactant or surfactant blend is formulated so as to exhibit a cleaning benefit for a variety of stains such as oily stains, waxy stains, sebum stains and particulate stains.

Anionic Surfactant

The anionic surfactant component is present in an amount of from about 3% to about 10% by weight of the composition.

The anionic surfactant component is present in amounts equal to or above a minimum amount at which at least partial removal of stains and soils occurs. In a preferred embodiment of the invention, the liquid laundry detergent comprises an amount of anionic surfactant component in the range of from about 2% by weight to about 7% by weight.

Alkyl ether sulfate (AES) is the primary choice of anionic surfactant due to ability to help provide dye fixing properties as compared to other more traditional anionic surfactants, such as linear alkyl benzene sulfonate (LAS) which has been show to have detrimental color-care effects. Additionally, the AES is selected as the primary anionic surfactant due to its ability to help stabilize the formula in the presence of the dye fixative (DFC-6). In another exemplary embodiment of the present invention, the AES material contains from about 8 to 18 carbon atoms or any combination of alkyl ether sulfates having from about 8 to 18 carbon atoms. The ethylene oxide content may be from 1 to 9 moles. The AES material may comprise a water-solubilizing cation formed of an alkali metal. In a preferred embodiment of the invention the anionic surfactant material comprises an AES having about 12 to 14 carbon atoms and about 2 moles of ethylene oxide. In a more preferred embodiment, the AES material comprises sodium lauryl ether sulfate.

Amphoteric Surfactant

The amphoteric surfactant component is present in an amount of from about 0.5% to about 5% by weight of the composition.

Suitable amphoteric surfactants include water soluble betaines and/or mixtures thereof, such as amido betaines including, cocoamidoethylbetaine, cocoamidopropyl betaine and the like. Preferred betaines are coco (C.sub.8-C.sub.18) amidopropyl dimethyl betaine or cocodimethyl betaine. Preferred mixtures include, Cocoamidopropyl Betaine (and) Cocamide MEA, such as is available from McIntyre as Mackam BC-39. Other suitable amphoteric surfactants may also be employed.

Dye Fixative

The cationic dye fixative is present in an amount of from about 0.1% to about 2.0% by weight of the composition. Preferably, the dye fixative materials are selected so as not to form precipitates with the essentially-utilized anionic surfactant. Suitable selected dye fixatives useful herein may be in the form of unpolymerized materials, oligomers or polymers. The non-precipitating dye fixatives useful herein include a number that are commercially marketed by CLARIANT Corporation under DFC6. Dye fixing agents, or “fixatives”, are well-known, commercially available materials which are designed to improve the appearance of dyed fabrics by minimizing the loss of dye from fabrics due to washing. Some include cellulose dye fixatives, including cellulose reactive dye fixing agents containing a cellulose reactive moiety, such as halogeno-triazines, vinyl sulphones, epichlorhydrine derivatives, hydroxyethylene urea derivatives, formaldehyde condensation products, polycarboxylates, glyoxal and glutaraldehyde derivatives, and mixtures thereof.

Redeposition Inhibitor

The polymer component is present in an amount of from about 0.1% to about 1% by weight of the composition. Preferably the polymer component is water-soluble and will preferably comprise a polyvinyl pyrrolidone polymer. The polyvinylpyrrolidone (PVP) used in the compositions of the invention is a linear homopolymer or essentially a linear homopolymer comprising at least 90% repeat units derived from 1-vinyl-2-pyrrolidone monomers. Other synonyms for PVP include povidone, polyvidone, 1-vinyl-2-pyrolidinone, and 1-ethenyl-2-pyrolionone (CAS registry number 9003-39-8). The PVP used in the present invention suitably has a weight average molecular weight of about 10,000 to 250,000, preferably 30,000 to 100,000. Such materials are sold by various companies, including ISP Technologies, Inc. under the trademark PLASDONE™ K-29/32, BASF under the trademark KOLLIDON™ for USP grade PVP, for example KOLLIDON™ K-30 or K-90. It is to be understood, however, that the invention is not limited to any specific PVP and that any equivalent PVP of acceptable purity may be used. Polyvinyl pyrrolidone is available from a variety of sources.

Liquid Carrier

The preferred liquid carrier for use in accordance with an exemplary embodiment of the present invention is water, which can be distilled, deionized, or unrefined tap water. In a preferred aspect of an exemplary embodiment, the liquid carrier comprises at least about 85% by weight of water; however, so long as sufficient water is present in the composition to effectively solubilize and/or disperse the other components of the composition, less water may be used. In another aspect of a preferred embodiment of the invention, wherein zinc ricinoleate is employed as the metallic salt, it is preferable that water comprise at least about 10% by weight of the composition so as to activate the zinc ricinoleate molecules as described hereinabove.

Fragrance

The fragrance component is present in an amount of from about 0.1% to about 1% by weight of the composition. Any suitable now known or hereafter devised fragrance or perfume material may be used in the compositions of the present invention.

Optional Additives

In other exemplary embodiments of the present invention, the composition may include one or more other conventional additives, such as, for example, pH adjusting agents, preservatives, chlorine scavenging agents, chelating agents, soil release agents, foaming or antifoaming agents, optical brighteners, enzymes, enzyme stabilizing agents, bacteriocides, fungicides, antistatic agents, miticides, insect repellants, colorants, and the like. One or more of such additives may be present in any amount suitable to achieve a particular objective.

It is preferable to utilize a preservative agent that is effective to inhibit and/or control both bacteria and fungi. When present, the water-soluble microbial preservative is included at an effective amount. The term “effective amount” as herein defined means a level sufficient to prevent spoilage or to prevent growth of microorganisms for a specific period of time, but not a level enough to affect the performance of the composition. Preferred levels of preservative, when present, are from about 0.01% to about 0.5% by weight of the composition, more preferably from about 0.02% to about 0.2% by weight of the composition, and most preferably from about 0.05% to about 0.1% by weight of the composition.

Suitable preservatives may include any organic preservative that will not adversely affect or damage fabric articles in the amounts present in the detergent compositions of the present invention. Preferred water-soluble preservatives include, for example, halogenated compounds, hydantoin compounds, organic sulfur compounds, low molecular weight aldehydes, cyclic organic nitrogen compounds, quaternary compounds, dehydroacetic acid, phenyl and phenoxy compounds, and mixtures thereof. In accordance with an aspect of an exemplary embodiment of the present invention, an effective amount of Dowicil® 75 preservative, available from Dow Chemical Co. of Midlans, Mich., or Dantogard® preservative, available from Lonza Group of Switzerland, is utilized in a detergent composition.

Chelating Agent

The compositions of the present invention optionally comprise from about 0.001%, preferably from about 0.01% to about 10%, preferably on the order of about 0.06% of a chelant. Preferred chelants according to the present invention can be selected from the group consisting of amino carboxylates, amino phosphonates, polyfunctionally-substituted aromatic chelating agents and mixtures thereof, all as hereinafter defined and all preferably in their acidic form. Amino carboxylates useful as chelating agents herein include ethylenediaminetetraacetic acid (EDTA), N-hydroxyethylethylenediaminetriacetates, nitrilotriacetates (NTA), ethylenediamine tetraproprionates, ethylenediamine-N,N′-diglutamates, 2-hyroxypropylenediamine-N,N′-disuccinates, triethylenetetraaminehexacetates, diethylenetriaminepentaacetates (DTPA) and ethanoldiglycines, including their water-soluble salts such as the alkali metal, ammonium, and substituted ammonium salts thereof and mixtures thereof.

pH Adjusting Agents

For optimum odor control and to maintain clarity of the composition, it is preferable that the pH of the composition be adjusted to less than about 8, more preferably less than about 6, and most preferably from about 3 to about 5. Various pH-adjusting agents are known in the art and can be used to bring the pH of the composition of the instant invention to within the preferred range. In one aspect of an exemplary embodiment of the invention, the pH-adjusting agent is selected from the group consisting of citric acid, lactic acid, phosphoric acid, and mixtures thereof. In one aspect of a preferred embodiment of the invention, citric acid is present in an amount effective to adjust the pH of the composition to within the preferred pH range, generally in an amount from about 0.1% to about 1.0% by weight of the composition.

In a preferred embodiment of the invention, these additives, alone or combined, are not present in an amount that is greater than about 4% by weight of the composition. More preferably, these additives, alone or combined, are present in an amount that is less than about 2% by weight of the composition, and even more preferably, less than about 1% by weight of the composition. However, any effective amount of optional additives, alone or combined, may be utilized in accordance with the present invention insofar as such additives do not detrimentally affect the desired properties of the laundry detergent composition.

The following is a non-limiting example of one embodiment of the invention. The components are mixed to form a clear, homogeneous microemulsion.

| Component | Weight % |
|---|---|
| Water | 77.5 |
| Sodium Laureth Sulfate | 5.0 |
| 9 EO Linear Alcohol | 10.0 |
| Sodium Chloride | 2.0 |
| Cocoamidopropyl betaine | 3.0 |
| DFC-6 | 1.50 |
| Polyvinylpyrrolidone | 0.25 |
| Citric Acid | 0.25 |
| Perfume | 0.25 |
| EDTA | 0.20 |
| Dye | 0.0040 |
| Preservative | 0.10 |
| Sodium Hydroxide | 0.05 |

A detergent composition according to various aspects of the present invention may be prepared by combining the surfactants by any convenient method of mixing, such as, for example, by rapidly stirring with a mechanical stirrer or by agitating with a mechanical agitator. Any other components, such as the inorganic materials and the polymers (PVP, DFC-6) should be added near the end of the manufacturing process with sufficient mixing to promote a clear homogeneous mixture. Citric Acid is used to bring the pH to the optimum range (6.5-7.0). Dye and Fragrance will be added as needed.

Various principles of the invention have been described in illustrative embodiments.

However, many combinations and modifications of the above-described structures, arrangements, proportions, elements, materials and components, used in the practice of the invention, in addition to those not specifically described, may be varied and particularly adapted to specific environments and operating requirements without departing from those principles. Stated another way, the above description presents exemplary modes contemplated in carrying out the invention and the techniques described are susceptible to modifications and alternate constructions from the embodiments shown above. Other variations and modifications of the present invention will be apparent to those of ordinary skill in the art, and it is the intent of the appended claims that such variations and modifications be covered.

Consequently, it is not the intention to limit the invention to the particular embodiments disclosed. On the contrary, the invention is intended to cover all modifications and alternate constructions falling within the scope of the invention, as expressed in the following claims when read in light of the description. No element described in this specification is necessary for the practice of the invention unless expressly described herein as “essential” or “required.”

1. A liquid laundry detergent composition having improved color-care properties comprising:
an anionic surfactant component;
a nonionic surfactant component;
an amphoteric surfactant component;
a cationic dye fixative;
a polymer component;
a fragrance component; and
a liquid carrier.

2. The composition of claim 1, wherein said anionic surfactant component is present in an amount of from about 3% to about 10% by weight of the composition.

3. The composition of claim 1, wherein said nonionic surfactant component is present in an amount of from about 5% to about 12% by weight of the composition.

4. The composition of claim 1, wherein said amphoteric surfactant component is present in an amount of from about 0.5% to about 5% by weight of the composition.

5. The composition of claim 1, wherein said cationic dye fixative is present in an amount of from about 0.1% to about 2.0% by weight of the composition.

6. The composition of claim 1, wherein said polymer component is present in an amount of from about 0.1% to about 1% by weight of the composition.

7. The composition of claim 1, wherein said fragrance component is present in an amount of from about 0.1% to about 1% by weight of the composition.

8. The composition of claim 1, further comprising at least one of a pH adjusting agent, a preservative, a chlorine scavenging agent, a chelating agent, a soil release agent, a foaming agent, an antifoaming agents, an optical brightener, enzymes, an enzyme stabilizing agent, a bacteriocide, a fungicide, an antistatic agent, a miticide, an insect repellant, a colorant, and mixtures thereof.
